(19) United States
(12) Patent Application Publication
(10) Pub. No.: US 2011/0035935 A1
(43) Pub. Date: Feb. 17, 2011

(54) HEAT SINK FAST DISASSEMBLING STRUCTURE

(75) Inventors: Ching-Yuan CHEN, Shen Tsun City (CN); Pen-Chun YU, Shen Tsun City (CN)

Correspondence Address: Ching-Ling Huang, 5597 NW 127th Ter, Portland, OR, 97229, US

(73) Assignee: Pen-Chun YU, Shen Tsun City (CN)

(21) Appl. No.: 12/539,627

(22) Filed: Aug. 12, 2009

(51) Int. Cl. B23P 19/00

(52) U.S. Cl. 29/726

(57) ABSTRACT

A heat sink fast disassembling structure dissipates heat from a heat source through a heat sink includes a base installed on a electronic device and a bracing rack connecting to the base. The base has an opening corresponding to the heat source and a first positioning portion. The bracing rack has a fastening portion mounted onto the heat sink and a connecting portion connecting to the base. The connecting portion has a second positioning portion corresponding to the first positioning portion. The bracing rack and the base are interposed by an elastic element. The first and second positioning portions form an anchoring relationship through the elastic element. The heat sink is in contact with the heat source through the anchoring relationship and the connecting portion via the opening. The bracing rack can be installed or disassembled through the first and second positioning portions and the elastic element.

### FIELD OF THE INVENTION

The present invention relates to a heat sink fast disassembling structure and particularly to a fast disassembling structure mounted onto a heat source of an electronic device to facilitate installation and disassembling of the heat sink.

### BACKGROUND OF THE INVENTION

With constant improvement of computer performance, computer operation temperature also becomes higher. For instance, on the central processing unit (CPU) of the computer, the motherboard is the operation center to provide high speed processing of data and calculation. A great amount of heat is generated and could become overheated. Hence effective heat dissipation and cooling are essential to maintain regular CPU operation. To meet this end, a heat sink is commonly installed above the CPU to dissipate the heat generated by the CPU during high speed operation.

References of heat sink adoptable to the CPU can be found in R.O.C. patent Nos. M345466, M341872 and M282232. They commonly have a latch device fastened to a motherboard by screwing to mate a CPU and a heat sink mounted onto the latch device to transmit heat energy of the CPU. A cooling fan may also be added and mounted on the heat sink to improve cooling efficiency. While they can provide cooling effect, they still have drawbacks in practice, notably:

1. During installation, the heat sink has to be fastened to the latch device first, then the latch device is fastened by screwing individually. Installation is tedious and time-consuming. Replacement or upgrade of the heat sink has to unfasten the screws one by one.

2. The depths of the screws fastened to the latch device do not have the same accuracy and even tightness. Some screws are tighter while others are looser. As a result, the force of the latch device pressing the CPU is not uniform. Cooling effect and CPU regular operation are affected.

### SUMMARY OF THE INVENTION

The primary object of the present invention is to solve the aforesaid disadvantages and save installation and disassembling time of the heat sink and provide an even pressure from the heat sink to a contacted heat source.

To achieve the foregoing object, the present invention provides a heat sink fast disassembling structure installed on an electronic device to dissipate heat of a heat source through a heat sink. It includes a base and a bracing rack connecting to the base. The base is mounted onto an electronic device and has an opening corresponding to a heat source and a first positioning portion. The bracing rack has a fastening portion installed on the heat sink and a connecting portion located in the opening to connect to the base. The connecting portion has a second positioning portion corresponding to the first positioning portion. The bracing rack and the base are interposed by an elastic element. The first and second positioning portions maintain a desired positioning relationship through the elastic element. Through the positioning relationship, the heat sink is in contact with the heat source through the connecting portion and the opening. And the heat sink can be installed on the base or disassembled therefrom through the bracing rack and the corresponding positioning portions and the elastic element.

Compared with the conventional techniques, the construction of the invention set forth above makes installation and disassembling of the heat sink easier and faster, and cooling efficiency also improves.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is another exploded view of the invention.

FIGS. 4A, 4B and 4C are schematic views of the invention in operating conditions.

FIG. 5 is a schematic view of an embodiment of the invention.

### DETAILED DESCRIPTION OF THE PREFERRED EMBODIMENT

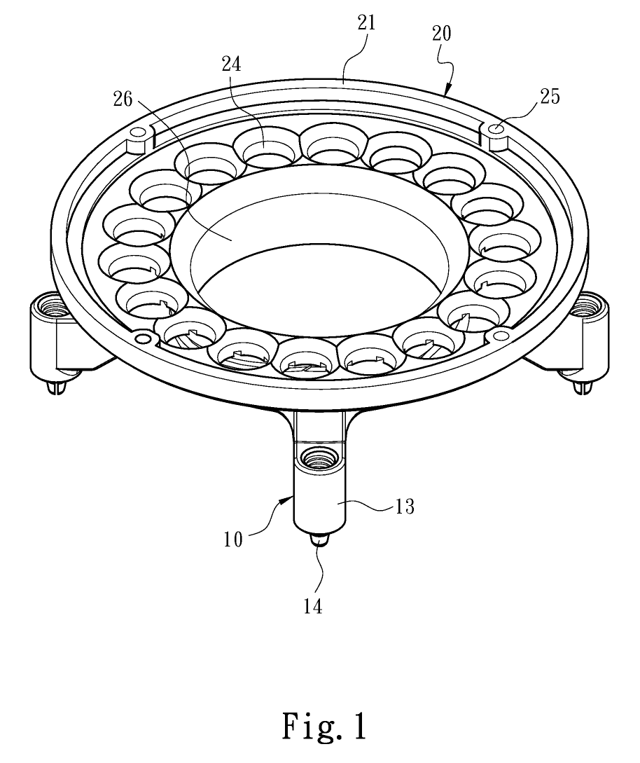

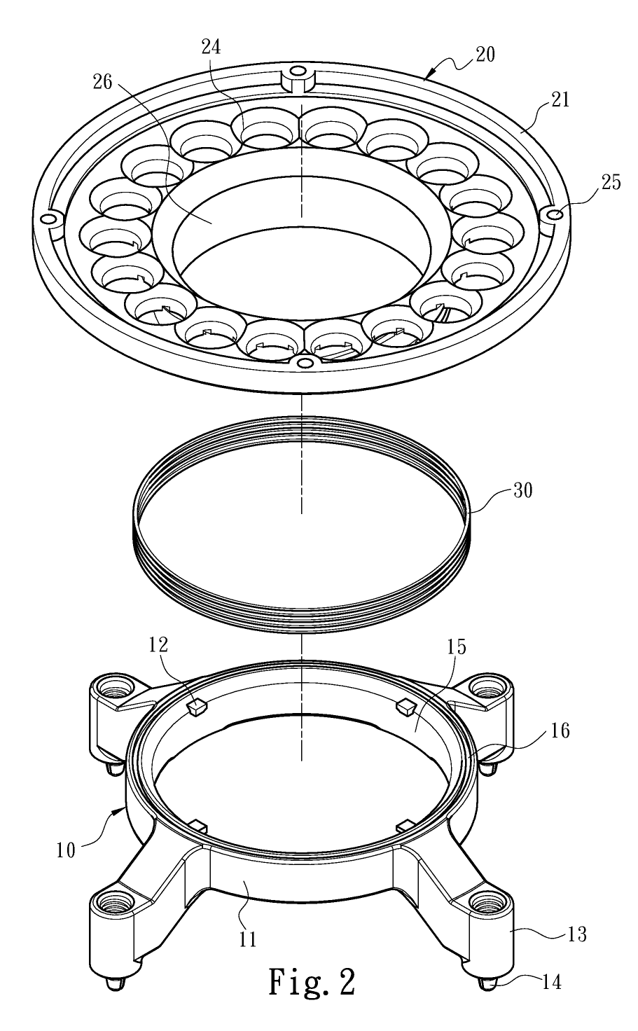

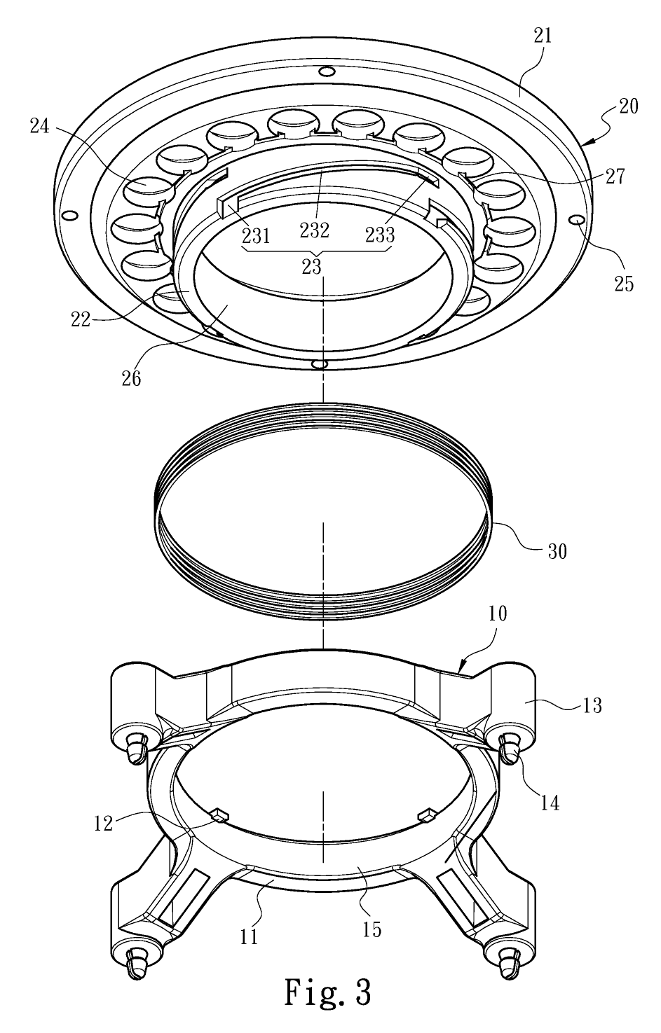

Please refer to FIGS. 1, 2 and 3, the present invention provides a heat sink fast disassembling structure installed on an electronic device to dissipate heat of a heat source in the electronic device by a heat sink. It has a base 10 and a bracing rack 20 connecting to the base 10. The base 10 has an annular coupling portion 11 with an opening 15 formed thereon and anchoring portions 13 on the periphery each has a tenon 14 formed thereon to mount the base 10 onto the electronic device to be cooled. The coupling portion 11 has a first positioning portion 12 in the opening 15. The bracing rack 20 has a fastening portion 21 with fastening holes 25 formed thereon to engage with screws to fasten the heat sink. The fastening portion 21 has a plurality of cooling vents 24 to dissipate heat from the heat sink and a connecting portion 22 extended in the opening 15 to connect to the coupling portion 11. The connecting portion 22 has a passage 26 communicating with the fastening portion 21 and corresponding to the opening 15, and a second positioning portion 23 corresponding to the first positioning portion 12. The bracing rack 20 and the base 10 further are interposed by an elastic element 30. The elastic element 30 is annular and located on the connecting portion 22 of the bracing rack 20. The base 10 and the bracing rack 20 also have respectively a holding trough 16 and 27 to anchor two ends of the elastic element 30 to prevent the elastic element 30 from sliding. The first positioning position 12 and second positioning portion 23 form an anchoring relationship through the elastic element 30. The bracing rack 20 is installable on and disassembling from the base 10 through the first and second positioning portions 12 and 23 and the elastic element 30.

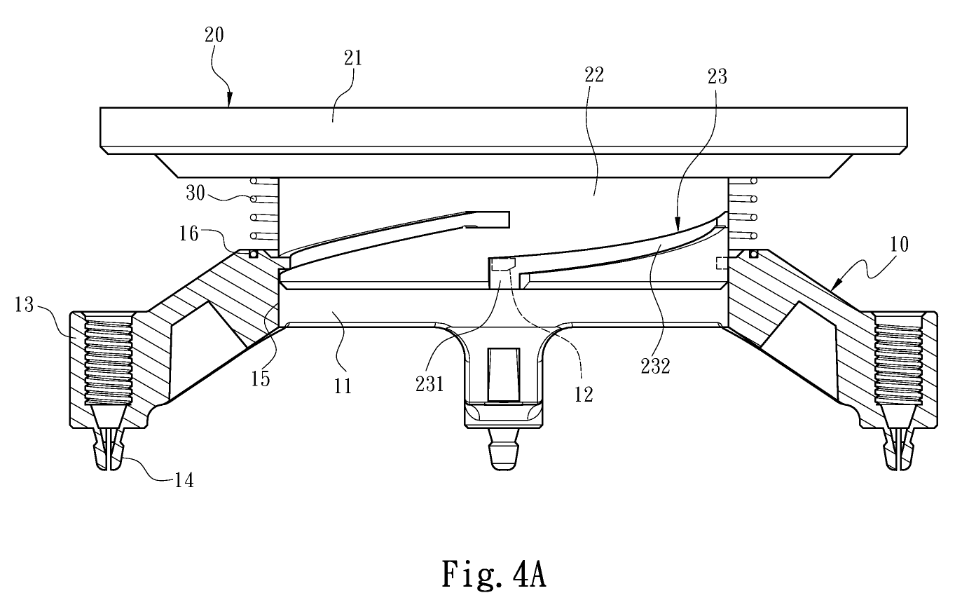

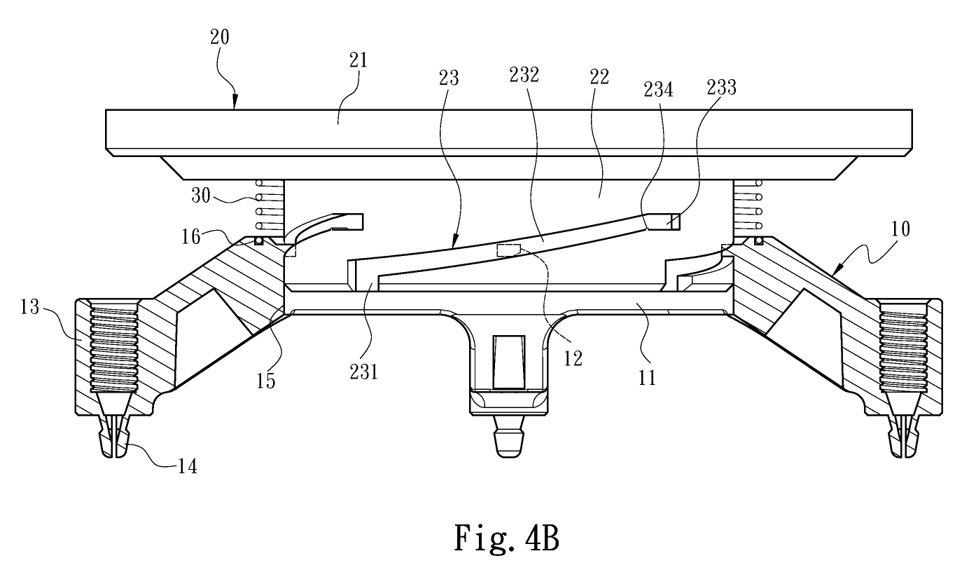

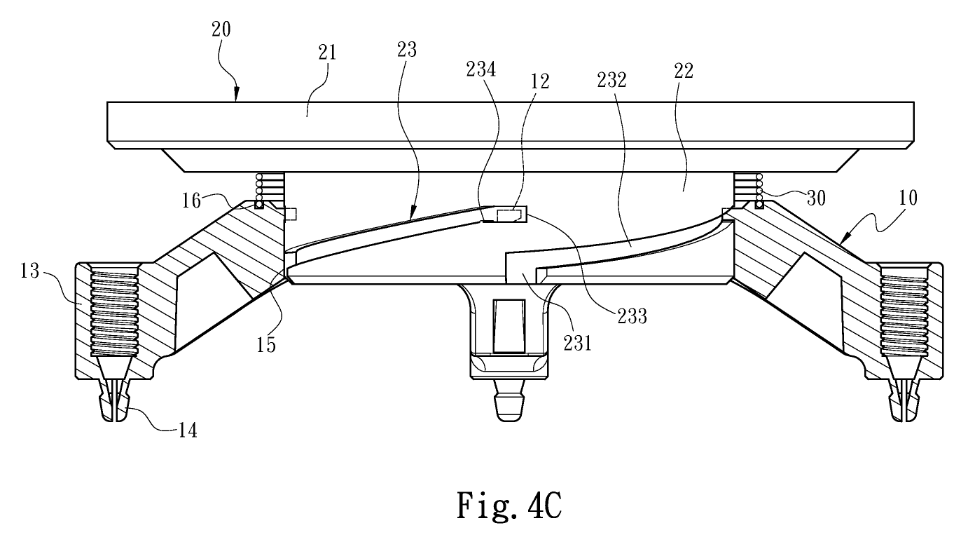

In an embodiment of the invention, the first and second positioning portions 12 and 23 are respectively a bump and a track mating each other. The track has a start section 231 to receive the bump, a movement section 232 communicating with the start section 231 and allowing the bump to move therein, and a position section 233 communicating with the movement section 232 to position the bump. The start section 231 and the position section 233 are formed at different elevations to form a height difference between them. Hence the movement section 232 is formed in a inclined manner. To install the bracing rack 20 on the base 10, referring to FIGS. 4A, 4B and 4C, first align the second positioning portion 23 of the bracing rack 20 with the first positioning portion 12 of the base 10 so that the first positioning portion 12 enters the start section 231 of the second positioning portion 23 (referring to FIG. 4A); next, press the bracing rack 20 and turn to move the first positioning portion 12 towards the movement section 232 of the second positioning portion 23, meanwhile the bracing rack 20 compresses the elastic element 30 (as shown in FIG. 4B) until the first positioning portion 12 is moved to the position section 233 of the second positioning portion 23. Hence the base 10 and the bracing rack 20 are braced and butted by the elastic force of the elastic element 30 so that the second positioning portion 23 leans on the wall of the position section 233. The wall of the position section 233 has a detent element 234 formed thereon to brake the bump of the second positioning portion 23. Therefore, the first and second positioning portions 12 and 23 form an anchoring relationship (referring to FIG. 4C). And the bracing rack 20 is installed on the base 10. By contrast, to disassemble the bracing rack 20 from the base 10, first, apply an opposite turning force on the first and second positioning portions 12 and 23 to release the anchoring relationship, and move the first positioning portion 12 away from the position section 233 to the start section 231 of the second positioning portion 23. Then the bracing rack 20 and the base 10 can be separated.

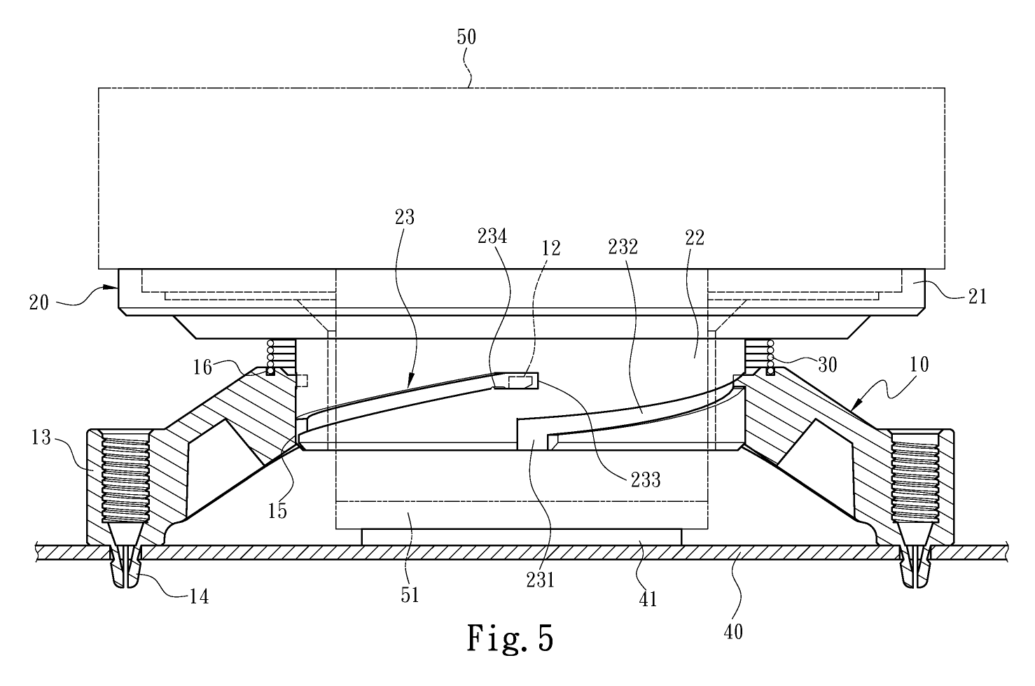

Refer to FIG. 5 for an embodiment of the invention. The base 10 is installed on a circuit board 40, and the tenon 14 of the anchoring portion 13 runs through the circuit board 40 so that the base 10 is fixedly mounted onto the circuit board 40. The opening 15 of the base 10 is corresponding to a heat source 41 of the circuit board 40, such as CPU, a processing chip or the like. The fastening portion 21 of the bracing rack 20 has a radiation fin 50 located thereon and extended to the passage 26 with one end edge connecting to a cooling element 51. When the bracing rack 20 and the base 10 are in the anchoring relationship, the cooling element 51 is in connect with the heat source 41 to transmit heat to the radiation fin 50 to dissipate heat. Through the height difference of the start section 231 and the position section 233 of the second positioning portion 23, the cooling element 51 compresses the heat source 41 at a selected force. By changing the bracing rack 20 of varying specifications to adjust the height difference, the depressing depth of the bracing rack 20 can be controlled and the compressing force of the cooling element 51 and the radiation fin 50 on the heat source 41 can be determined. Through the elastic force of two ends of the elastic element 30 pushing the base 10 and the bracing rack 20, the cooling element 51 can evenly compress the heat source 41 to improve cooling efficiency.

As a conclusion, the present invention provides the base 10 to be mounted onto an electronic device that has an opening 15 corresponding to the heat source of the electronic device. It also has the bracing rack 20 equipped with a heat sink and a connecting portion 22 located in the opening 15 to connect to the base 10. The base 10 and the bracing rack 20 are interposed by the elastic element 30 and have respectively the first and second positioning portions 12 and 23 corresponding to each other to form an anchoring relationship through the elastic force of the elastic element 30. The heat sink is in contact with the heat source through the connecting portion 22 via the opening 15 in the anchoring relationship. Through the first and second positioning portions 12 and 23 and the elastic element 30, the bracing rack 20 is installed on the base 10, meanwhile the heat sink is in contact with the heat source to dissipate heat. Similarly, through the first and second positioning portions 12 and 23 and the elastic element 30, the bracing rack 20 can be separated from the base 10. Installation and disassembling can be done faster and easier. The elastic element 30 keeps the heat sink in contact with the heat source at a uniform force and results in improved cooling efficiency.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A heat sink fast disassembling structure mounted onto an electronic device to perform heat dissipation of a heat source through a heat sink, comprising:
a base which is mounted onto the electronic device and has an opening corresponding to the heat source and a first positioning portion; and
a bracing rack which has a fastening portion installed on the heat sink and a connecting portion located in the opening and connected to the base, the connecting portion having a second positioning portion corresponding to the first positioning portion;
wherein the bracing rack and the base are interposed by an elastic element to form an anchoring relationship between the first positioning portion and the second positioning portion, the heat sink being in contact with the hear source through the anchoring relationship and the connecting portion via the opening.

2. The heat sink fast removing structure of claim 1, wherein the first positioning portion is a bump and the second positioning portion is a track.

3. The heat sink fast removing structure of claim 2, wherein the track has a start section to receive the bump, a movement section communicating with the start section to receive movement of the bump and a position section communicating with the movement section to anchor the bump.

4. The heat sink fast removing structure of claim 3, wherein the position section has a detent element to brake the bump.

5. The heat sink fast removing structure of claim 3, wherein the start section and the position section are formed at an elevation difference so that the movement section is formed inclinedly.

6. The heat sink fast removing structure of claim 1, wherein the base has a coupling portion to hold the opening and connect to the connecting portion and an anchoring portion located on the coupling portion to connect to the electronic device.

7. The heat sink fast removing structure of claim 6, wherein the anchoring portion has a tenon running through the electronic device.

8. The heat sink fast removing structure of claim 1, wherein the base and the bracing rack have respectively a holding trough to anchor two ends of the elastic element.

9. The heat sink fast removing structure of claim 1, wherein the elastic element is a spring surrounding the connecting portion of the bracing rack.

10. The heat sink fast removing structure of claim 1, wherein the connecting portion of the bracing rack has a passage communicating with the fastening portion and corresponding to the opening of the base.

11. The heat sink fast removing structure of claim 1, wherein the fastening portion of the bracing rack has fastening holes to engage with screws to fasten the heat sink.

12. The heat sink fast removing structure of claim 1, wherein the fastening portion of the bracing rack has a plurality of cooling vents.
